(19) United States
(12) Patent Application Publication
(10) Pub. No.: US 2008/0201166 A1
(43) Pub. Date: Aug. 21, 2008

(54) SYSTEM AND METHOD TO BILL A HEALTHCARE ENTITY FOR USE OF AN ASSET OF A SUPPLIER

(75) Inventors: Adrian F. Warner, Delafield, WI (US); Crispian Sievenpiper, Waukesha, WI (US)

Correspondence Address: PETER VOGEL;GE HEALTHCARE, 20225 WATER TOWER BLVD., MAIL STOP W492, BROOKFIELD, WI, 53045, US

(73) Assignee: GENERAL ELECTRIC COMPANY, Schenectady, NY (US)

(21) Appl. No.: 11/675,885

(22) Filed: Feb. 16, 2007

(51) Int. Cl. G06Q 50/00

(52) U.S. Cl. 705/2

(57) ABSTRACT

A system to bill a healthcare entity for use of an asset of a supplier is provided. The system includes a computer in communication to track use of the asset, and a computer readable storage medium having programmable instructions for execution by the computer. The programmable instructions include receiving a request from the healthcare entity for use of the asset; identifying an identifier correlated to the request, the identifier correlated to a request for reimbursement from the insurer; tracking use of the asset by the healthcare entity; detecting receipt of the reimbursement at the healthcare entity from the insurer; calculating a percentage of the reimbursement to bill the healthcare entity for use of the asset correlated to the reimbursement; and generating an output for communication to the healthcare entity. The output includes a display that shows the identifier and the percentage of the reimbursement billed to the healthcare entity.

### BACKGROUND OF THE INVENTION

This invention generally relates to a financial billing system, and more specifically to a system and method of charging customers for miscellaneous use or consumption of assets owned by a supplier.

Various types of assets (e.g., products, systems) are utilized in the treatment or diagnosis of a patient. For example, there are a wide variety of products (e.g., contrast agents, drugs, anesthesia, oxygen, etc.) consumed in the diagnosis and treatment of a patient. There are also various types of systems that are used in the diagnosis or treatment of a patient, such as medical imaging systems (e.g., ultrasound, fluoroscopic, x-ray, magnetic resonance (MR), computerized tomography (CT), positron emission tomography (PET), laparoscopic, etc.) that have been developed to image a wide variety of organs and tissues of the human body. In another example, there exists a wide variety of other systems (e.g., anesthesia machines, patient monitoring stations, heart rate monitors, laboratory machines, nuclear medicine devices, etc.) employed in the medical monitoring, diagnosis, and treatment of a patient. Many of the above-described assets are associated with high purchase costs, which are passed down to the consumer. Unfortunately, many healthcare providers lack the resources to cover the initial purchase costs so as to provide the most technological advanced medical services and equipment to their customers. Also, it is typically difficult to track the actual use of the respective medical products and equipment for a specific patient for billing purposes.

### BRIEF DESCRIPTION OF THE INVENTION

Accordingly, there is a need for an enhanced system and methods to track and bill customers (e.g., healthcare entities such as hospitals, clinics, etc.) for use of a supplier asset for at least the reasons described above. The above-mentioned need is addressed by the embodiments described herein in the following description.

In accordance with one embodiment of the subject matter described herein, a system to bill a healthcare entity for use of a medical product or asset of a supplier is provided. The system includes a computer in communication to track use of the asset. The system further includes a computer readable storage medium having a plurality of programmable instructions for execution by the computer. The programmable instructions include receiving a request at the computer for use of the asset; receiving at least one token from the healthcare entity, the tokens representative of a monetary payment; enabling use of the asset upon receipt of the at least one token; tracking use of the asset by the healthcare entity; calculating an expenditure of credit in accordance to tracked use of the asset, the expenditure of credit evaluated in a bill of tokens; calculating a balance equal to a difference of the receipt of the at least one token less the bill of tokens; and generating an output that includes a display illustrative of the balance for communication to the healthcare entity.

In accordance with another embodiment, a system to bill a healthcare entity for use of a medical product or asset of a supplier in the medical care of a patient covered by an insurer is provided. The system includes a computer in communication to track use of the asset, the system including a computer readable storage medium having a plurality of programmable instructions for execution by a processor, the programmable instructions including receiving a request from the healthcare entity for use of the asset; identifying an identifier correlated to the request, the identifier correlated to a request for reimbursement from the insurer; tracking use of the asset by the healthcare entity; detecting by the supplier of a receipt of the reimbursement at the healthcare entity as received from the insurer related to the use of the asset in treatment of the patient, the reimbursement correlated to the identifier; calculating a percentage of the reimbursement billed to the healthcare entity for use of the asset correlated to the reimbursement; and generating an output for communication to the healthcare entity, the output including a display that shows the identifier and the percentage of the reimbursement billed to the healthcare entity.

In accordance with yet another embodiment, a system to bill a healthcare entity for use of a medical product or asset of a supplier is provided. The system includes a meter and a computer in communication with the asset. The computer includes a computer readable storage medium having a plurality of programmable instructions for execution by a processor. The programmable instructions include receiving a request for use of the asset; measuring an amount of data output flowing from use of the asset via the meter; calculating an expenditure in accordance to the value of the data output from use of the asset; and generating an output that includes a display illustrative of the value of the data output and the expenditure billed to the healthcare entity.

Systems and methods of varying scope are described herein. In addition to the aspects and advantages described in this summary, further aspects and advantages will become apparent by reference to the drawings and with reference to the detailed description that follows.

### BRIEF DESCRIPTION OF THE DRAWINGS

FIG. 1 shows a schematic diagram of one embodiment of a system to bill a healthcare entity for use or consumption of an asset of a supplier in medical care of a patient.

FIG. 2 illustrates a schematic diagram of one embodiment of a software operable to bill a healthcare entity for use or consumption of the asset of the supplier in medical care of a patient in accordance with FIG. 1.

FIG. 3 shows a schematic diagram of another embodiment of a software operable to bill a healthcare entity for use or consumption of the asset of the supplier in medical care of a patient in accordance with FIG. 1.

FIG. 4 shows a schematic diagram of yet another embodiment of a software operable to bill a healthcare entity for use or consumption of the asset of the supplier in medical care of a patient in accordance with FIG. 1.

FIG. 5 shows a schematic diagram of yet another embodiment of a software operable to bill a healthcare entity for use or consumption of the asset of the supplier in medical care of a patient in accordance with FIG. 1.

### DETAILED DESCRIPTION OF THE INVENTION

In the following detailed description, reference is made to the accompanying drawings that form a part hereof, and in which is shown by way of illustration specific embodiments, which may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken in a limiting sense.

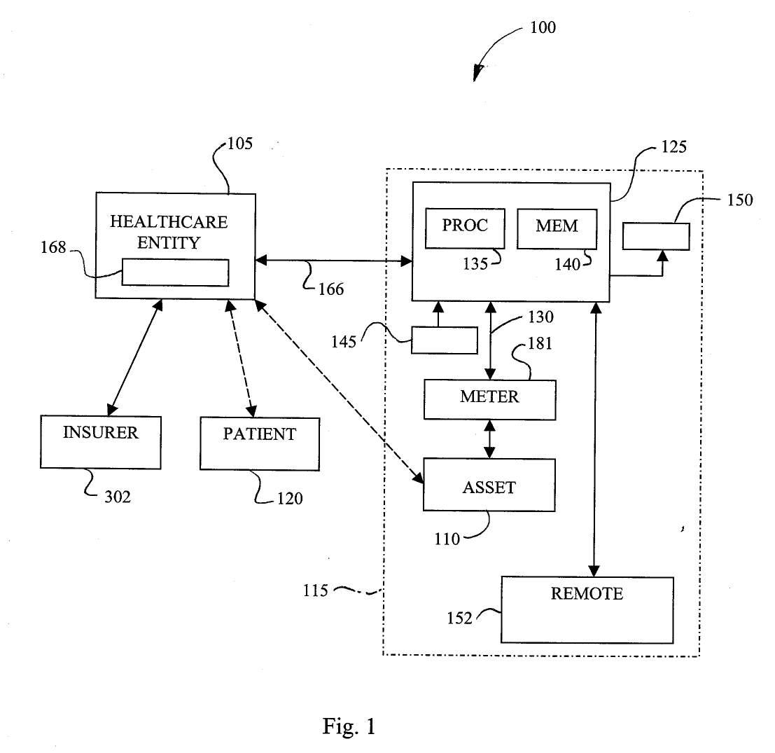

FIG. 1 illustrates one embodiment of a system 100 for billing or charging a customer such as a healthcare entity (e.g., hospital, clinic, etc.) 105 for use or consumption of an asset 110 owned by a supplier (e.g., GENERAL ELECTRIC®, PHILIPS®, SIEMENS®, TOSHIBA®, etc.) 115 in providing medical care to a patient 120. One of the technical effects of the system 100 is that the healthcare entity 105 is billed or charged for use of the asset 110 by the supplier 115 based on representation of payment credit at a location of the asset 110. Thereby, the healthcare entity 105 is able to provide the most technically advanced medical assets (e.g., services and products) to the patient 120 without the burden of covering the typical substantial purchase costs associated with technically advanced assets 110.

Examples of the asset 110 can include various types of medical equipment, such as a patient monitor (e.g., bone mineral densitometry, maternal/infant care, life support systems, heart monitor, etc.) employed in monitoring patient vital signs (e.g., blood pressure, pulse, etc.) and patient care. The asset 110 can also include laboratory analysis systems (e.g., immunoassay analysis, bioassay analysis, confocal cell imager, chromatography, etc.) employed in medical diagnosis or analysis. The asset 110 can also include systems employed in the imaging of a region of interest of the patient 120. The types of imaging systems include x-ray, computed tomography (CT), magnetic resonance (MR), mammography, ultrasound, fluoroscopy, positron emission transmission (PET), endoscopic, laparoscopic, etc. The asset 110 can also include a picture archive and communication system (PACS) operable to receive a series of images generated by one or more of the above-described imaging systems for storage and later retrieval by the healthcare entity for display and/or analysis. The asset 110 can also include various products or compositions (e.g., contrast agents, radioisotopes, etc.) used and consumed in combination with use of one or more of the above-described imaging systems. The asset 110 can also include algorithms accessed by the healthcare entity 105 in the analysis of acquired input data (e.g., images, physiological waveforms, etc.).

The system 100 generally includes a computer 125 of the supplier 115 connected in communication to track or measure use of the asset 110. One embodiment of the computer 125 is connected so as to move with movement of the asset 110. The computer 125 is attached by a connection 130 (e.g., wired connection, wireless, etc.) so as to enable tracking of use or consumption of the asset 110. An embodiment of the computer 125 can be in a desktop configuration or laptop configuration. Yet, the type of computer can vary.

An embodiment of the computer 125 generally includes one or more processors 135 in communication with a memory 140 having a computer-readable storage medium. The storage medium is operable to receive and store a plurality of programmable instructions for execution by the processor 135. An embodiment of the computer 125 also is connected in communication with an input device 145 and an output device 150. The input device 145 can include one or combination of a keyboard, touch-screen, remote computer workstation, mouse, etc. or the like operable to receive data from an operator. The output device 150 can include a display comprising one or combination of a monitor, an alarm, light emitting diodes (LEDs), printer, etc. operable to visually or audibly show an output of the computer 125 for illustration to an operator of the healthcare entity 105. The computer 125 can also be connected in communication with a remote computer station 152 of the supplier 115.

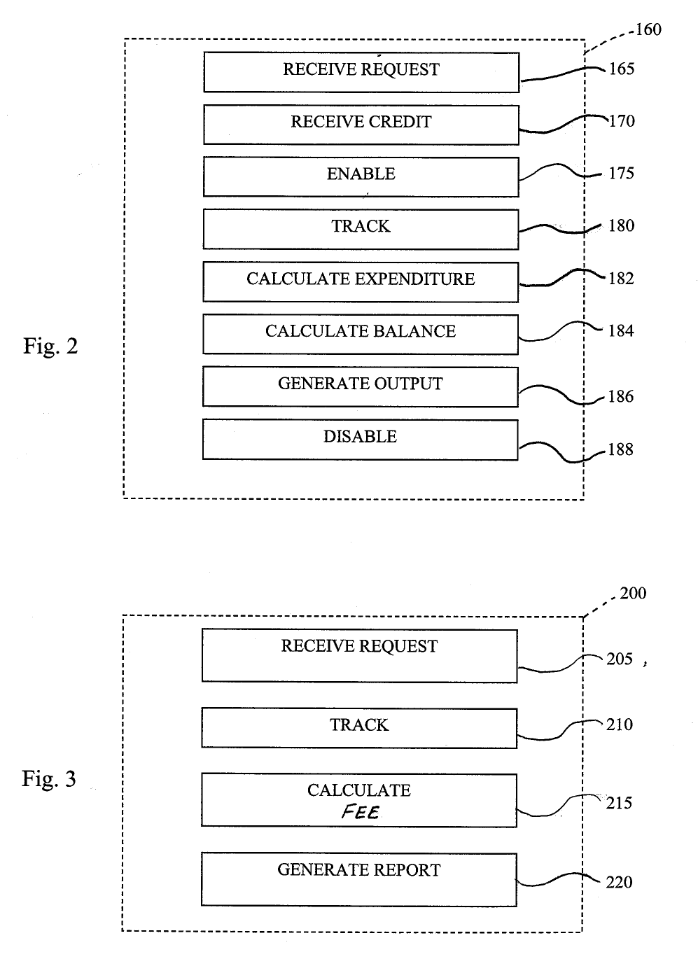

FIG. 2 illustrates one embodiment a software 160 comprising computer-readable program instructions stored in the memory 140 for execution by the computer 125. The software 160 comprises a first module 165 that includes programmable instructions to receive a request for use of the asset 110 of the supplier 115. An embodiment of the request is received via a connection 166 (e.g., wired, wireless, internet, etc.) in communication with a computer station 168 of the healthcare entity 105. Alternatively, the request can be received via the input device 145. A second module 170 includes instructions to receive a representation of a payment credit received from the healthcare entity 105. An embodiment of the representation of payment credit includes an actual monetary value (e.g., U.S. dollars, euros, etc.) or a token representative of a predetermined monetary value (e.g., per one-hundred dollars, per schedule of predetermined charge per use of the medical product). The representation of payment credit is electronically transferred via an Internet connection from a computer station of the healthcare entity to the supplier, or via a download from a local connection of the computer 125 in communication with a laptop or similar portable computing device of the healthcare entity 105. A third module 175 includes instructions to enable use of the asset 110 upon receipt of the representation of payment credit. The receipt of the representation of payment credit is compared so as to determine whether at least equal or exceeds a schedule of a predetermined charge per use of the asset 110.

A fourth module 180 includes instructions to track the healthcare entity's use of the asset 110. An embodiment of the tracking is performed via a meter 181 connected in communication with the computer 125 so as to communicate a measured use or consumption of the asset 110 to the computer 125. Examples of the meter 181 include a timer, a counter, known type of volumetric or weight measurement device operable to measure quantity of product consumed, pressure or pulse measurement device, etc.). The meter 181 can be independent or integrated with the computer 125.

A fifth module 182 includes instructions to calculate an expenditure of credit in accordance to the predetermined charge per use and the tracked use of the asset 110. A sixth module 184 includes instructions to calculate a balance of credit equal to a difference of the representation of payment credit less the expenditure of the credit for use of the asset 110. A seventh module 186 includes instructions to generate an output illustrative of the balance of credit for illustration in a monitor or other type of display at the workstation 168 of the healthcare entity 105. An embodiment of the seventh module 186 includes instructions to automatically dump the output (e.g., acquired images, measured data, etc.) associated with the tracked use of the asset 110 to the remote computer station 168 of the healthcare entity 105 for illustration to an operator. The output can also be communicated for illustration at the output device 150 of the computer 125. An embodiment of the output is a display of a bill with a description of the request of the asset 110, the tracked use of the asset 110, the calculated expenditure of credit for use of the asset 110, and the balance of credit of the healthcare entity 105. The software 160 can also include an eighth module 188 including instructions to disable use of the asset 110 upon calculating the balance of credit equal to or less than a threshold. If use of the asset 110 is disabled, the seventh module 186 can generate output that includes a description of the request for use of the asset 110 and the needed payment credit to enable use of the asset 110.

FIG. 3 illustrates another embodiment of a software 200 that in combination with the system 100 of FIG. 1 is operable to bill the healthcare entity 105 for use of the asset 110 of the supplier 115. A technical effect of the software 200 is to bill the healthcare entity 105 for use of the asset 110 at a fee schedule for various levels of operation of the asset 110, including but not limited to, training, idling in a standby mode, or generating an output associated with its intended purpose (e.g., image acquisition, providing anesthesia to a patient, monitoring of a patient, etc.).

As shown in FIG. 3, a first module 205 includes instructions for receiving a request for use of the asset 110. A second module 210 includes instructions for tracking a time of operation (e.g., analyzing, imaging, etc.) of the asset 110 while in use by the healthcare entity 105. The second module 210 also includes instructions for tracking an idle time (e.g., powered down) of the asset 110. For example, the operation mode of the asset 110 can include generating an output (e.g., image, measured physiological waveform, etc.) from use of the asset 110 in accordance with the received request. A third module 215 includes instructions for calculating a first fee in accordance to the measured time of operation of the asset 110, and a second fee in accordance to an idle time of the asset 110. The first fee is higher than the second fee because the asset 110 is consuming greater energy when operating in comparison to when the asset 110 is idling in standby mode. Thus, unless the asset 110 is completely switched off, a residual charge is incurred when the asset 110 is standing idle. The third module 215 also includes instructions for calculating a total fee equal to a sum of the first and second fees. The third module 215 can also include program instructions to reduce or null the total fee during service intervals on the asset 110. A fourth module 220 includes instructions for generating an output with a display illustrative of the total billed fee for communication to the healthcare entity 105. An embodiment of the output includes a breakdown of the different levels of use (e.g., operation vs. idle time) of the asset 110 and respective fees.

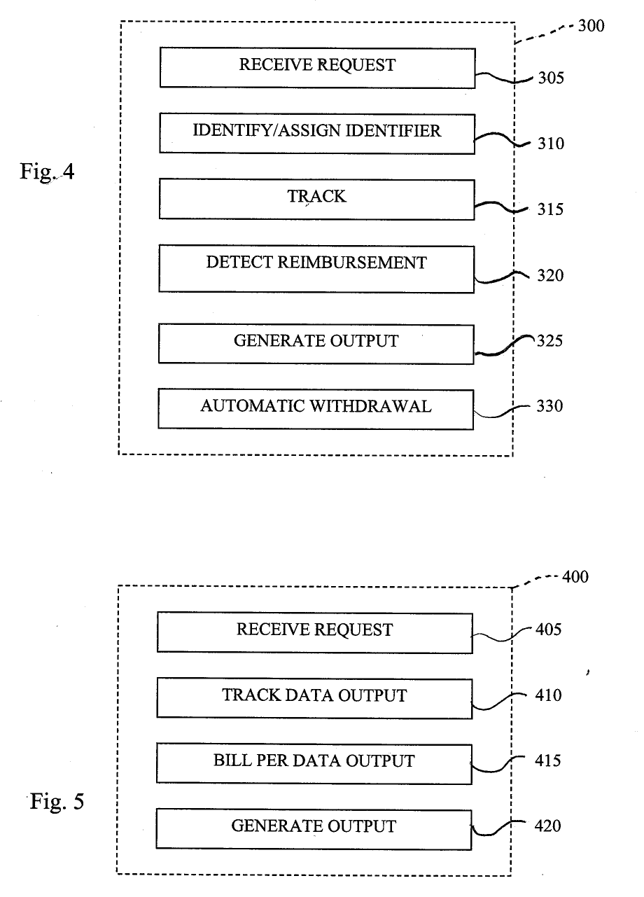

FIG. 4 shows another embodiment of a software 300 operable to generate a bill to the healthcare entity 105 for use of the asset 110 owned by the supplier 115. A technical effect of the software 300 is to bill the healthcare entity 105 upon detecting reimbursement received at the healthcare entity 105 by an insurer 302 (See FIG. 1) of the patient 120 receiving medical care via use of the asset 110. In accordance with one embodiment, reimbursement of the healthcare entity 105 is tracked via an identifier assigned by the healthcare entity 105 in requesting reimbursement from the insurer 302 with respect to providing medical care to the patient 120 covered by the insurer 302. One embodiment of the identifier is one of a series of billing codes assigned by the healthcare entity 105 for the respective use of the asset 110. Another embodiment of the identifier is a patient identifier (e.g., name, social security number, etc.) assigned to the patient 120 receiving benefits of use or consumption of the asset 110.

As shown in FIG. 4, the software 300 comprises a first module 305 that includes program instructions for receiving a request for use of the asset 110. A second module 310 includes instructions for identifying identifier associated with the request. One embodiment of the identifier includes a billing code assigned in accordance with the request for use of the asset 110. The billing code can be received from in the request from the healthcare entity 105, or selected from a series of stored billing codes in accordance to keywords and assigned in association to the request. The billing code is the same as that submitted by the healthcare entity 105 for reimbursement from the insurer 302. An embodiment of the second module 310 includes a program instruction for receiving and storing a series of billing codes in combination with a predetermined fee schedule agreed upon between the insurer 302 and the healthcare entity 105. Examples of the series of billing codes include at least one of a healthcare common procedure coding system (HCPCS), an international classification of diseases-Clinical Modification Diagnosis and Procedure Coding System (ICD-CM); current procedural terminology (CPT) coding system; diagnostic related group (DRG) classification system. The insurer 302 can be a public (e.g., Medicare, Medicaid) provider or private provider. The third module 315 includes instructions for tracking use of the asset 110 by the healthcare entity 105. The fourth module 320 includes instructions for detecting a reimbursement received by the healthcare entity 105 from the insurer 302 for providing medical care associated with use of the asset 110 to the patient 120 enrolled or covered under a policy of the insurer 302. The fifth module 325 includes instructions for generating an output that includes a request or bill for a percentage of the reimbursement received by the healthcare entity 105, along with the associated billing code. The software 300 further includes a sixth module 330 with program instructions for automatically withdrawing monetary funds from the healthcare entity 105 via an electronic transfer in payment of the request for the percentage of the reimbursement received by the healthcare entity 105.

Another embodiment of the second module 310 described above can include program instructions to identity and/or assign a patient identifier (e.g., given name, numeric reference, alphanumeric reference, etc.) in response to receiving the request from the healthcare entity 105. The patient identifier may also be included the request for reimbursement submitted by the healthcare entity 105 to the insurer 302 for medical care provided to the patient 120 covered by the insurer 302.

FIG. 5 shows includes an embodiment of a software 400 employed in combination with the system 100 of FIG. 1 to bill the healthcare entity 105 for use or consumption of the asset 110. The software 400 comprises a first module 405 that includes program instructions to receive a request for use of the asset 110. A second module 410 includes program instructions to track or measure an amount or value of data output flowing from use of the asset 110, such as to the computer station 168 of the healthcare entity 110. An embodiment of the meter 181 is operable to measure the amount of data output from use of the asset 110 for communication to the computer 125. A third module 415 includes program instructions to calculate an expenditure in accordance to the amount of the measured amount of data output measured and communicated by the meter 181. An embodiment of the expenditure is calculated by multiplying a predetermined fee per amount of data output by the measured amount of data output. A fourth module 420 includes program instructions to generate an output that includes an illustration of the amount of the data output and the respective expenditure in a bill to the healthcare entity 105. The output can communicated to the computer station 168 of the healthcare entity 105 and to the output device 150 located at the asset 110, as well as to the remote computer station 152 of the supplier 115.

Although specific embodiments of software 200, 300 and 400 are described above in combination with the system, it should be that one or more of the modules described with respect to one embodiment of software 200, 300 and 400 can added in combination with one of the other embodiments of the software 200, 300, and 400 and is not limiting on the subject matter described herein. It should also be understood that each embodiment of the software 200, 300, and 400 can include additional modules of programming instructions not described herein. Also, the embodiments of the software 200, 300, and 400 may not include each described module of programming instructions.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A system to bill a healthcare entity for use of an asset owned by a supplier, the system including a computer in communication to track use of the asset, the system further including a computer readable storage medium having a plurality of programmable instructions for execution by the computer, the programmable instructions including:
receiving a request at the computer for use of the asset;
receiving at least one token from the healthcare entity, the tokens representative of a monetary payment;
enabling use of the asset upon receipt of the at least one token;
tracking use of the asset by the healthcare entity;
calculating an expenditure of credit in accordance to tracked use of the asset, the expenditure of credit evaluated in a bill of tokens;
calculating a balance equal to a difference of the receipt of the at least one token less the bill of tokens; and
generating an output that includes a display illustrative of the balance for communication to the healthcare entity.

2. The system as recited in claim 1, wherein the asset includes at least one of a patient monitor, an imaging system, a picture archival system, a laboratory analysis system.

3. The system as recited in claim 1, wherein the asset includes a diagnostic contrast agent.

4. The system as recited in claim 1, wherein the programmable instructions further include disabling use of the asset by the healthcare entity upon calculating the balance below a threshold value.

5. The system as recited in claim 4, wherein the computer is attached in communication with the asset.

6. A system to bill a healthcare entity for use of an asset of a supplier in the medical care of a patient covered by an insurer, the system including a computer in communication to track use of the medical product, the system including a computer readable storage medium having a plurality of programmable instructions for execution by a processor, the programmable instructions including:
receiving a request from the healthcare entity for use of the asset;
identifying an identifier correlated to the request, the identifier correlated to a request for reimbursement from the insurer;
tracking use of the asset by the healthcare entity;
detecting by the supplier of a receipt of the reimbursement at the healthcare entity as received from the insurer related to the use of the asset in treatment of the patient, the reimbursement correlated to the identifier;
calculating a percentage of the reimbursement billed to the healthcare entity for use of the asset correlated to the reimbursement; and
generating an output for communication to the healthcare entity, the output including a display that shows the identifier and the percentage of the reimbursement billed to the healthcare entity.

7. The system of claim 6, wherein the identifier includes one of a plurality of billing codes predetermined between the insurer and the healthcare entity to be included in a request for reimbursement from the insurer.

8. The system as recited in claim 7, wherein the programming instructions further include:
receiving and storing the plurality of billing codes and a fee schedule correlated to the plurality of billing codes; and
automatically transferring a predetermined percentage of the reimbursement received at the healthcare entity for payment to the supplier.

9. The system as recited in claim 6, wherein the plurality of billing codes include at least one of a healthcare common procedure coding system (HCPCS), an international classification of diseases-Clinical Modification Diagnosis and Procedure Coding System (ICD-CM); current procedural terminology (CPT) coding system; diagnostic related group (DRG) classification system.

10. The system as recited in claim 6, wherein the programming instructions further include:
calculating a percentage of the reimbursement to bill the healthcare entity for use of the asset of the supplier,
wherein the bill to the healthcare entity is the percentage of the reimbursement.

11. The system of claim 6, wherein the programmable instructions further include:
receiving a request for use of the asset;
tracking an active time duration of operation that the asset is generating an output;
tracking an idle time duration that the asset is not generating an output;
calculating a first fee in accordance to the active time duration and a second fee in accordance to the idle time duration, the first fee different than the second fee; and
calculating a total fee equal to a sum of the first and second fees; and
generating an output that includes a display of a bill for the total fee for communication to the healthcare entity.

12. The system of claim 6, wherein the identifier includes a patient identifier correlated to the use of the asset of the supplier.

13. The system of claim 6, wherein the asset includes at least one of a patient monitor, an imaging system, a picture archival system, a laboratory analysis system.

14. The system as recited in claim 6, wherein the asset includes a diagnostic contrast agent.

15. A system to bill a healthcare entity for use of an asset of a supplier, the system including:
a meter and a computer in communication with the asset, the computer including a computer readable storage medium having a plurality of programmable instructions for execution by a processor, the programmable instructions including:
receiving a request for use of the asset;
measuring an amount of data output flowing from use of the asset via the meter;
calculating an expenditure in accordance to the value of the data output from use of the asset; and
generating an output that includes a display illustrative of the value of the data output and the expenditure billed to the healthcare entity.

16. The system of claim 15, wherein the asset includes at least one of a patient monitor, an imaging system, a picture archival system, a laboratory analysis system.

17. The system as recited in claim 15, wherein the asset includes a diagnostic contrast agent.

18. The system as recited in claim 15, wherein the healthcare entity is billed per byte of data.

19. The system as recited in claim 15, wherein the programming further include:
detecting receipt of a reimbursement at the healthcare entity correlated to insurance coverage of the patient;
automatically transferring a predetermined percentage of the reimbursement received at the healthcare entity for payment to the supplier for use of the asset.

20. The system as recited in claim 15, wherein the computer is integrated with the meter and is attached so as to move with movement of the asset.
